(19) United States
(12) Patent Application Publication
(10) Pub. No.: US 2019/0075913 A1
(43) Pub. Date: Mar. 14, 2019

(54) WATER BOTTLE

(71) Applicant: Shenzhen Xinyuetang Plastic&Hardware Co., Ltd, Shenzhen (CN)

(72) Inventor: Lihua Huang, Shenzhen (CN)

(21) Appl. No.: 16/108,940

(22) Filed: Aug. 22, 2018

(30) Foreign Application Priority Data
Sep. 10, 2017 (CN) 201721153873.1

(51) Int. Cl. A45F 3/18; A47G 19/16; A47J 31/00; B65D 81/38

(52) U.S. Cl. CPC A45F 3/18; A47G 19/16; B65D 41/04; B65D 81/3876; A47J 31/005

(57) ABSTRACT

A water bottle includes a bottle body and at least one steel sheet. The steel sheet has an arc-shaped cross-section, and is flexibly movable, curled and wound around a periphery of the bottle body. A silicone sleeve is wrapped around the steel sheet. A pattern or text is provided on a curled outer side surface of the silicone sleeve curling around the bottle body. The water bottle is advantageous in that it is simple in structure, anti-scald, anti-drop, nice looking and highly interesting.

### CROSS REFERENCE TO RELATED APPLICATIONS

The present application claims the benefit of Chinese Utility Model Application No. 201721153873.1 filed on Sep. 10, 2017. All the above are hereby incorporated by reference.

### TECHNICAL FIELD

The present disclosure relates to a water bottle, and in particular to a water bottle which is simple in structure, anti-scald, anti-drop, nice looking and highly interesting.

### BACKGROUND

Water bottle is a daily necessity having a wide range of usage. It is generally used for containing water or other liquids. People usually carry a water bottle to facilitate drinking. However, the function of existing water bottles lacks variety. These water bottles are not very interesting and cannot meet people's growing needs in terms of usage.

### SUMMARY

In order to overcome the shortcoming of the existing technology, an object of the present disclosure is to provide a water bottle which is simple in structure, anti-scald, anti-drop, nice looking and highly interesting.

The object of the present disclosure can be realized by the following technical measures. A water bottle includes a bottle body and at least one steel sheet. The steel sheet has an arc-shaped cross-section, and is flexibly movable, curled and wound around a periphery of the bottle body. A silicone sleeve is wrapped around the steel sheet. A pattern or text is provided on a curled outer side surface of the silicone sleeve curling around the bottle body.

In a preferred embodiment, a plurality of steel sheets is arranged to cover an entire periphery of the bottle body.

In a preferred embodiment, the silicone sleeves of the plurality of steel sheets have different colors.

In a preferred embodiment, the bottle body is provided with upper and lower openings, and the upper and lower openings are respectively covered by upper and lower lids.

In a preferred embodiment, an inner bottom portion of the lower lid is provided with a tea strainer having a downwardly facing opening, an edge at the opening of the tea strainer is formed with an outwardly extending flange, and the flange is pressed against an edge of the lower opening of the bottle body by the lower lid.

In a preferred embodiment, the upper lid is provided with a handle.

In a preferred embodiment, the bottle body is a transparent glass bottle body.

In the water bottle of the present disclosure, at least one steel sheet is flexibly movable, curled and wound around the periphery of the bottle body of the water bottle. The length of the steel sheet may be greater than or equal to the perimeter of the periphery of the bottle body. A silicone sleeve is wrapped around the steel sheet. When the temperature of the liquid inside the water bottle is high, the silicone sleeve can produce an excellent anti-scald effect when the water bottle is held by the hands of a user. It can also produce an anti-drop effect. The outer side of the silicone sleeve can be provided with a pattern or text, thereby enriching the outer appearance of the water bottle. The pattern on the outside of the water bottle can be changed by replacing the steel sheets. After removing from the water bottle, the steel sheet can be wrapped around the user's wrist as a wrist strap, thus enhancing the interest of the water bottle.

### BRIEF DESCRIPTION OF THE DRAWINGS

FIG. 1 is a perspective view showing the structure of the water bottle according to an embodiment of the present disclosure.

FIG. 2 is an exploded view of an embodiment of the water bottle.

FIG. 3 shows schematic diagrams of a steel sheet in a curled state and a straightened state according to an embodiment of the present disclosure.

### DETAILED DESCRIPTION

The present disclosure is further described in detail with certain embodiments and the accompanying drawings.

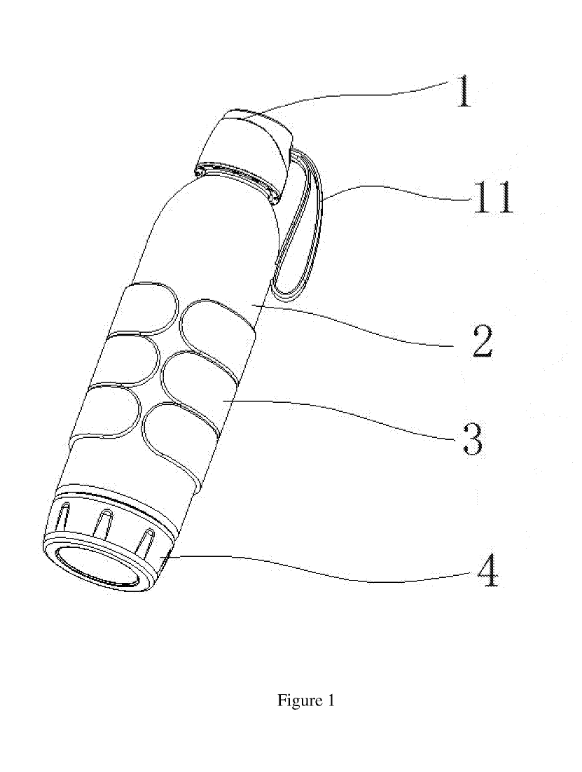

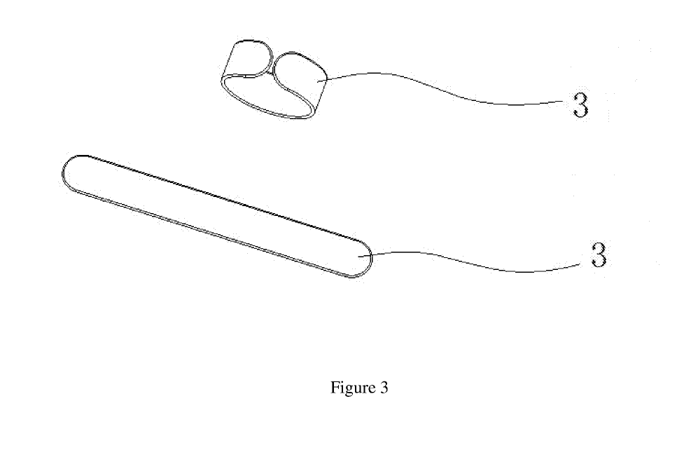

A water bottle, as shown in FIGS. 1 to 3, may include a bottle body 2 and at least one steel sheet 3. The steel sheet 3 may have an arc-shaped cross-section with a thinner middle region. The steel sheet 3 may be flexibly movable, curled and wound around a periphery of the bottle body 2. A silicone sleeve may be wrapped around the steel sheet 3. A pattern or text may be provided on a curled outer side surface of the silicone sleeve curling around the bottle body.

In the water bottle of the present disclosure, at least one steel sheet 3 may be flexibly movable, curled and wound around the periphery of the bottle body 2 of the water bottle. The length of the steel sheet 3 may be greater than or equal to the perimeter of the periphery of the bottle body 2. A silicone sleeve may be wrapped around the steel sheet 3. When the temperature of the liquid inside the water bottle is high, the silicone sleeve can produce an excellent anti-scald effect when the water bottle is held by the hands of a user. It can also produce an anti-drop effect. The outer side of the silicone sleeve can be provided with a pattern or text, thereby enriching the outer appearance of the water bottle. The pattern on the outside of the water bottle can be changed by replacing the steel sheets 3. After removing from the water bottle, the steel sheet 3 can be wrapped around the user's wrist as a wrist strap, thus enhancing the interest of the water bottle, and increasing its market competitiveness.

In the water bottle of the present disclosure shown in FIG. 1 and on the basis of the previous technical scheme, a plurality of steel sheets 3 can be arranged to cover an entire periphery of the bottle body 2. This can result in a better anti-scald and anti-drop effect.

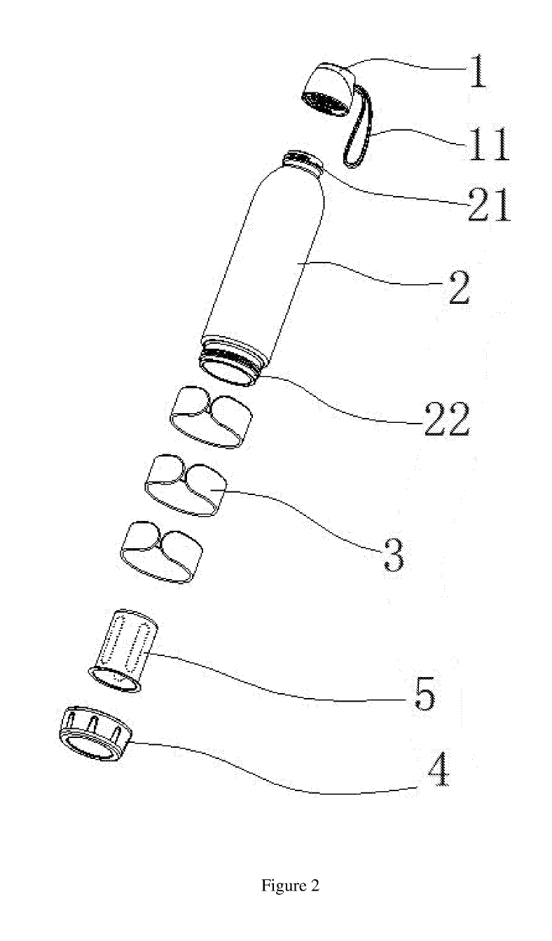

In the water bottle of the present disclosure shown in FIG. 2 and on the basis of the previous technical scheme, the silicone sleeves of the plurality of steel sheets 3 may have different colors. This can enhance the outer appearance of the water bottle.

In the water bottle of the present disclosure shown in FIG. 2 and on the basis of the previous technical scheme, the bottle body 2 may be provided with upper and lower openings 21, 22. The upper opening 21 may be covered by an upper lid 1. The lower opening 22 may be covered by a lower lid 4. This can facilitate opening of the upper lid 1 or the lower lid 4 for drinking of water.

In the water bottle of the present disclosure shown in FIG. 2 and on the basis of the previous technical scheme, an inner bottom portion of the lower lid 4 may be provided with a tea strainer 5 having a downwardly facing opening. An edge at the opening of the tea strainer 5 may be formed with an outwardly extending flange. The flange may be pressed against an edge of the lower opening 22 of the bottle body 2 by the lower lid 4. In this way, the tea strainer 5 can be securely installed. When tea leaves are put inside the tea strainer 5, they cannot pass through the opening. Hence, it can better meet the requirement of tea drinkers.

In the water bottle of the present disclosure shown in FIG. 1 and on the basis of the previous technical scheme, the upper lid 1 may be provided with a handle 11. This can facilitate the carrying of the water bottle.

In the water bottle of the present disclosure shown in FIG. 1 and on the basis of the previous technical scheme, the bottle body 2 may be a transparent glass bottle body. This allows the user to observe the volume and color of the liquid inside the water bottle. This makes the water bottle more convenient to use.

The above is a description that assists the understanding of the water bottle of the present disclosure. The embodying of the water bottle of the present disclosure is not limited by the above-described embodiments. Any alteration, modification, substitution, combination, and addition that do not depart from the principle of the water bottle of the present disclosure should be equivalent replacements that are encompassed within the scope of protection of the appended claims.

What is claimed is:

1. A water bottle comprising:
a bottle body;
at least one steel sheet, the steel sheet having an arc-shaped cross-section, and the steel sheet being flexibly movable, curled and wound around a periphery of the bottle body;
a silicone sleeve wrapped around the steel sheet; and
a pattern or text provided on a curled outer side surface of the silicone sleeve curling around the bottle body.

2. The water bottle according to claim 1, wherein a plurality of steel sheets is arranged to cover an entire periphery of the bottle body.

3. The water bottle according to claim 2, wherein the silicone sleeves of the plurality of steel sheets have different colors.

4. The water bottle according to claim 1, wherein the bottle body is provided with upper and lower openings, and the upper and lower openings are respectively covered by upper and lower lids.

5. The water bottle according to claim 4, wherein an inner bottom portion of the lower lid is provided with a tea strainer having a downwardly facing opening, an edge at the opening of the tea strainer is formed with an outwardly extending flange, and the flange is pressed against an edge of the lower opening of the bottle body by the lower lid.

6. The water bottle according to claim 4, wherein the upper lid is provided with a handle.

7. The water bottle according to claim 1, wherein the bottle body is a transparent glass bottle body.
